(19) United States
(12) Patent Application Publication
(10) Pub. No.: US 2005/0120147 A1
(43) Pub. Date: Jun. 2, 2005

(54) Direct memory access controller enabling cycle stealing among channels

(75) Inventor: Masayuki Koyama, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/821,985

(22) Filed: Apr. 12, 2004

(30) Foreign Application Priority Data
Dec. 1, 2003 (JP) 2003-401301(P)

(51) Int. Cl. G06F 13/28

(52) U.S. Cl. 710/22

(57) ABSTRACT

A DMAC is provided with a plurality of DMA transfer portions controlling DMA transfer in accordance with values set in a group of registers for current transfer. When the DMAC acquires bus ownership from a bus master, use of the bus is permitted among the plurality of DMA transfer portions in a prescribed order in response to transfer requests from the plurality of DMA transfer portions. Therefore, occupation of the bus ownership by a specific DMA channel can be prevented.

### BACKGROUND OF THE INVENTION

1. Field of the Invention

The present invention relates to a DMA (Direct Memory Access) controller having a plurality of channels and, more specifically, to a DMA controller that enables cycle stealing among channels.

2. Description of the Background Art

Recently, there is an ever-increasing demand for higher speed of processing of a system provided with a CPU (Central Processing Unit) and the like. To meet such a demand, a DMA function has been utilized that enables direct data input/output between an I/O (input/output) device and a memory and the like. Generally, a DMA controller is designed to allow DMA transfer of multiple channels. Japanese Patent Laying-Open Nos. 2000-207352 and 9-259071 disclose related techniques.

In a memory access contention control method disclosed in Japanese Patent Laying-Open No. 2000-207352, even when one DMAC has a bus ownership and a DMA transfer process is in progress with a shared memory, the DMA transfer process currently in progress is forcibly interrupted in response to a bus request signal from another DMAC having higher priority than the one DMAC, and the bus ownership is passed to the DMAC having higher priority.

In a communication controller disclosed in Japanese Patent Laying-Open No. 9-259071, when a first DMA controller channel is operating as a bus master and a bus ownership request is issued from a second DMA controller channel having higher priority than the first DMA controller channel, the first DMA controller channel immediately gives up the bus ownership. State of operation of the first DMA controller channel immediately preceding the abandonment is stored and held, and when the bus ownership is returned to the first DMA controller channel, the DMA transfer can be resumed continuously from the state of operation.

In a conventional DMA controller, when a specific channel of the DMAC starts DMA transfer, though a CPU access is possible during the DMA transfer, a DMA transfer by another DMAC channel has been impossible.

In the inventions disclosed in Japanese Patent Laying-Open Nos. 2000-207352 and 9-259071, when a channel of a DMAC is performing DMA transfer and a bus ownership request is issued by a DMA channel having higher priority, the bus ownership is surrendered to the DMA channel of higher priority. Here, until the end of the DMA transfer by the DMA channel of higher priority, other DMA channels are kept waiting to perform their own DMA transfers.

### SUMMARY OF THE INVENTION

An object of the present invention is to provide a DMAC that prevents monopoly of the bus ownership by a specific DMAC channel.

According to an aspect, the present invention provides a direct memory access controller including a plurality of direct memory access transfer portions controlling direct memory access transfer in accordance with values set in a group of registers for current transfer, and a control portion permitting use of a bus by the plurality of direct memory access transfer portions in a prescribed order, so that bus ownership is passed among channels at every prescribed number of transfers in response to a transfer request from the plurality of direct memory access transfer portions while the bus ownership is granted from a bus master.

Consequently, monopoly of the bus ownership by a specific channel can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents state transition of bus ownership acquisition among DMACs in accordance with an embodiment of the present invention.

FIG. 2 represents an example of a system in which the DMAC in accordance with an embodiment of the present invention is used.

FIG. 3 is a block diagram representing a schematic configuration of the DMAC in accordance with an embodiment of the present invention.

FIG. 4 is a block diagram representing a double-structure of the register groups in the DMAC in accordance with an embodiment of the present invention.

FIG. 5 represents a circuit configuration for controlling a cycle steal of each DMA channel.

FIG. 6 is a timing chart illustrating acquisition of bus ownership by the DMAC in accordance with an embodiment of the present invention.

### DESCRIPTION OF THE PREFERRED EMBODIMENTS

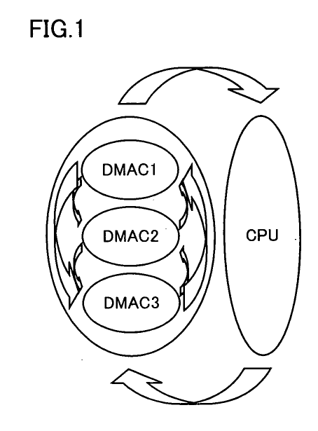

FIG. 1 represents state transition of bus ownership acquisition among DMACs in accordance with an embodiment of the present invention. As shown in FIG. 1, while any of DMAC 1 to DMAC 3 is performing DMA transfer, transition of bus ownership to and from a CPU is possible, and transition of bus ownership among DMAC 1 to DMAC 3 is also possible.

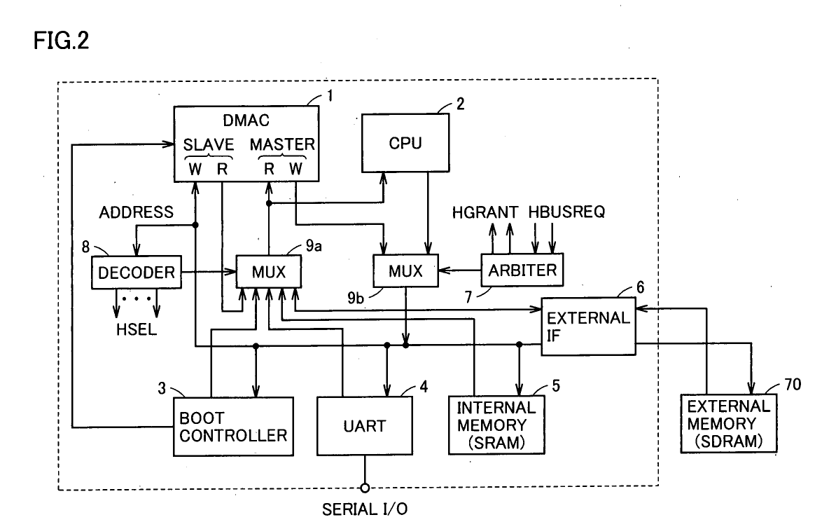

FIG. 2 represents an example of a system in which the DMAC in accordance with an embodiment of the present invention is used. The system includes a DMAC 1, a CPU 2, a boot controller 3, an UART (Universal Asynchronous Receiver-Transmitter) 4, an internal memory 5, an external IF 6 for controlling data input to/output from an external memory 70, an arbiter 7, a decoder 8 and multiplexers (MUX) 9a and 9b.

DMAC 1, CPU 2 and the like are master devices that function as a bus master. Boot controller 3, UART 4, internal memory 5 and external memory 70 are slave devices that can be accessed by the master device. DMAC 1 also functions as a slave device.

Master W of DMAC 1 refers to a group of signals including output signals HWDATAout, HADDRout, HWRITEout, HSIZEout, HTRANSout, HBURSTout, HPROTout and HLOCK, on the side of an AHB master IF, which will be described later. Master R of DMAC 1 refers to a group of signals including input signals HRDATAin, HRESPin and HREADYin on the side of the AHB master IF, which will be described later.

Slave W of DMAC 1 refers to a group of signals including input signals HWDATAin, HADDRin, HWRITEin, HSIZEin, HTRANSin on the side of an AHB slave IF, which will be described later. Slave R of DMAC 1 refers to a group of signals including output signals HRDATAout, HRESPout and HREADYout on the side of the AHB slave IF, which will be described later.

CPU 2 executes a program stored in internal memory 5, external memory 70 or the like, and performs operations for system control.

Decoder 8 receives an address (address in an output from MUX 9b) output from the master device, detects which device is to be accessed, and outputs an HSEL signal to the thus detected device as the object of accessing. DMAC 1 receives the HSEL signal from decoder 8.

MUX 9a is selectively controlled by decoder 8, receives groups of output signals from the plurality of slave devices, that is, boot controller 3, UART 4, internal memory 5, external memory 70 and DMAC 1, and selects and outputs one group of output signals.

Arbiter 7 receives bus request (HBUSREQ) signals from the plurality of master devices such as DMAC 1 and CPU 2, arbitrates among the master devices to determine to which device the bus ownership should be granted, and grants HGRANT signal to the device which is permitted to obtain the bus ownership. Therefore, DMAC 1 applies HBUSREQ signal to arbiter 7 and receives HGRANT signal from arbiter 7.

MUX 9b receives respective groups of output signals from the plurality of master devices including DMAC 1 and CPU 2, and selects and outputs one group of signals. Signal propagation from the plurality of devices to the inputs of MUXs 9a and 9b is through a plurality of separate buses that correspond to the plurality of devices, respectively. Signal propagation from the outputs of MUXs 9a and 9b to the plurality of devices is through a common bus.

Internal memory 5 is formed, for example, by an SRAM (static Random Access Memory). External memory 70 is formed, for example, by an SDRAM (Synchronous Dynamic Random Access Memory), and accessed from a master device through external IF 6.

Boot controller 3 is for controlling booting of CPU 2. Specifically, it applies BT_DMAREQ_P signal and BT_RAMSEL signal, which will be described later, to DMAC 1, and controls DMAC 1 so that a program necessary for booting is loaded.

UART 4 is connected to a serial port, and converts parallel data to serial data, or serial data to parallel data.

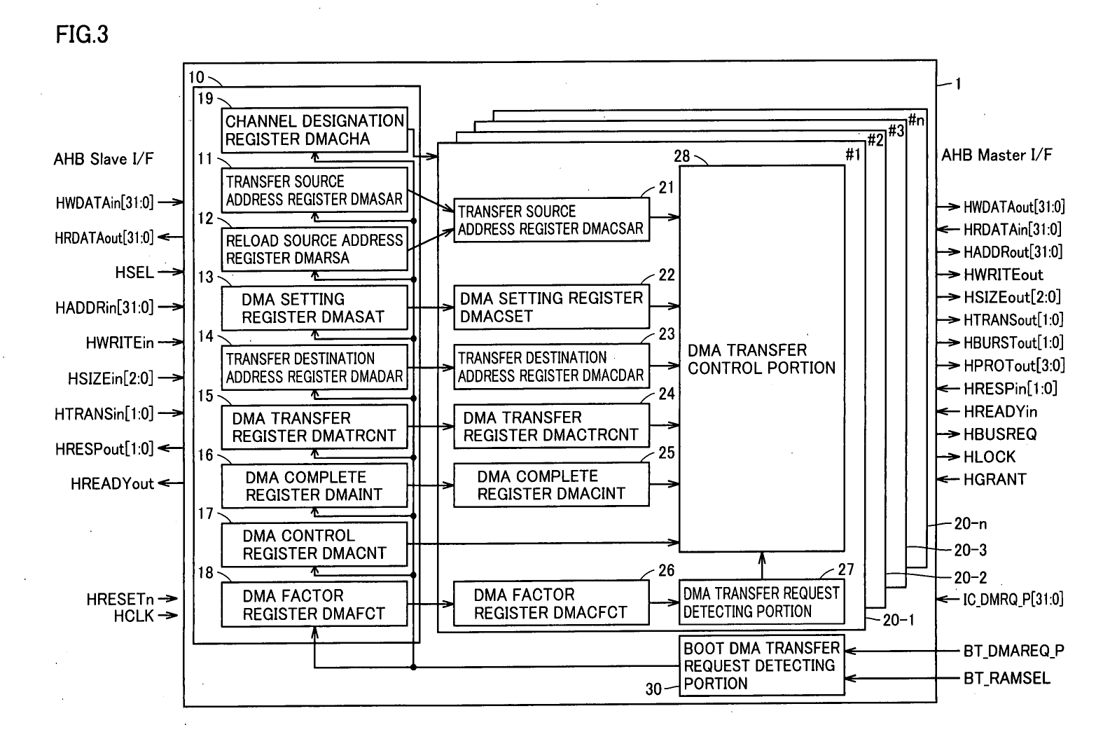

FIG. 3 is a block diagram representing a schematic configuration of the DMAC in accordance with the embodiment of the present invention. DMAC 1 includes a register group 10 for next transfer, DMA transfer portions 20-1 to 20-n same in number as the number of channels, and a boot DMA transfer request detecting portion 30. Meanings of various signals (except for IC_DMARQ_P signal, BT_DMARQ_P signal and BT_RMASEL signal) shown in FIG. 3 are described in a reference “AMBA™ Specification (Rev2.0)”, released from Advanced RISC Machines (ARM).

A group 10 of registers for next transfer includes a transfer source address register (DMASAR) 1 for next transfer, a reload source address register (DMARSA) 12 for next transfer, a DMA setting register (DMASET) 13 for next transfer, a transfer destination address register (MADAR) 14 for next transfer, a DMA transfer register (DMATRCNT) 15 for next transfer, a DMA complete register (DMAINT) 16 for next transfer, a DMA control register (DMACNT) 17, a DMA factor register (DMAFCT) 18 for next transfer, and a channel designation register (DMACHA) 19.

Each of DMA transfer portions 20-1 to 20-n includes a transfer source address register (DMACSAR) 21 for current transfer, a DMA setting register (DMACSET) 22 for current transfer, a transfer destination address register (DMACDAR) 23 for current transfer, a DMA transfer register (DMACTRCNT) 24 for current transfer, a DMA complete register (DMACINT) 25 for current transfer, a DMA factor register (DMACFCT) 26 for current transfer 26, a DMA transfer request detecting portion 27 and a DMA transfer control portion 28.

Register groups 11 to 18 and 21 to 16 have a double structure of a group of registers 11 to 18 for next transfer and a group of registers 21 to 26 for current transfer, and when DMA transfer set in the group of registers 21 to 26 for current transfer is completed, values that have been set in the group of registers 11 to 18 for next transfer are set to the group of registers 21 to 26 for current transfer, to be ready for the next DMA transfer.

CPU 2 writes contents of HWDATAin signal to registers 11 to 18 and reads contents of registers 11 to 18 as HRDATAout signal, using AHB salve IF of DMAC 1.

Transfer source address register 11 for next transfer stores a DMA transfer source address for next transfer. It is possible to read from/write to this register.

Reload source address register 12 for next transfer stores a DMA reload source address for next transfer. It is possible to read from/write to this register.

DMA setting register 13 for next transfer is for setting the method of DMA transfer, and it is possible to read from/write to this register. DMA setting register 13 includes 1 bit for designating whether the transfer source address is to be fixed or incremented, 1 bit for designating whether the transfer destination address is to be fixed or incremented, 2 bits for designating DMA transfer size (byte transfer, half word transfer, word transfer), and 4 bits for designating bus access ratio.

Transfer destination address register 14 for next transfer stores DMA transfer destination address for next transfer. It is possible to read from/write to this register.

DMA transfer register 15 for next transfer stores the number of DMA transfers for next transfer. It is possible to read from/write to this register.

DMA complete register 16 for next transfer stores the number of complete DMA transfers for next transfer. It is possible to read from/write to this register.

The number of transfers set in DMA transfer register 15 for next transfer is for designating values n and N, where data transfer of n-byte unit is to be performed N times. The number of completion set in DMA completion register 16 for next transfer designates how many sets of transfers set in DMA transfer register 15 for next transfer are to be performed.

DMA control register 17 is for controlling DMA transfer, and reading and writing of every bit thereof are possible. It includes 1 bit for designating whether DMA interruption is to be masked or not, 1 bit for designating whether DMA enable is to be automatically cleared or not, 1 bit for designating whether reload DMA transfer is to be enabled or not, 1 bit for indicating whether reloading is being performed or not, 1 bit for indicating whether DMA transfer is being performed, 1 bit for designating whether a DMA request is to be accepted or not, and 1 bit for designating whether DMA transfer lock is to be enabled or not.

DMA factor register 18 for next transfer is for setting factor of DMA transfer for every DMA channel, and in which, types of devices that output DMA transfer requests and information whether a DMA transfer request is a level trigger or an edge trigger and the like, are set. It is possible to read from/write to this register.

Channel designation register 19 stores information specifying to which DMA transfer portion corresponding to which channel the contents of transfer registers 11 to 18 for next transfer are to be transferred. Therefore, contents of registers 111 to 18 are transferred to the DMA transfer portion corresponding to the channel that is designated by the contents of channel designating register 19. It is possible by channel designating register 19 to designate a plurality of possible channels.

In transfer source address register 21 for current transfer, a transfer source address set in transfer source address register 11 for next transfer or a reload source address set in reload source address register 12 is set. It is noted that CPU 2 cannot read from or write to registers 21 to 26, and under the control of internal DMA control portion 20, contents of registers 11 to 18 are written to registers 21 to 26 and the contents of registers 21 to 26 are read to DMA transfer control portion 28.

In DMA setting register 22 for current transfer, a value that has been set in DMA setting register 13 for next transfer is set.

In transfer destination address register 23 for current transfer, a transfer destination address that has been set in transfer destination address register 14 for next transfer is set. This register is read-only.

In DMA transfer register 24 for current transfer, a value that has been set in DMA transfer register 15 for next transfer is set. This register is read-only.

In DMA complete register 25 for current transfer, a value that has been set in DMA complete register 16 for next transfer is set. This register is read-only.

In DMA factor register 26 for current transfer, a value that has been set in DMA factor register 18 for next transfer is set. This register is read-only.

DMA transfer request detecting portion 27 receives an external DMA transfer request signal IC_DMRQ_P [31:0], and outputs a DMA transfer request to DMA transfer control portion 28 in accordance with a value set in DMA factor register 26 for current transfer.

Boot DMA transfer request detecting portion 30 receives a DMA transfer request signal BT_DMAREQ_P from boot controller 3, and detects a boot request. Channel #1 only is adapted to operate in response to the boot request, and therefore, data corresponding to the boot request are set in the group of registers 11 to 18 for next transfer and information designating channel #1 is set in channel designation register 19.

DMA transfer control portion 28 controls DMA transfer in accordance with the group of registers 21 to 26 for current transfer, DMA transfer request detected by DMA transfer request detecting portion 27 and the like. The group of signals listed on the left side of FIG. 3 represents group of signals on the slave side I/F (Interface) of AHB (Advanced High-performance Bus), and the group of signals listed on the right side of FIG. 3 represents group of signals on the master side I/F of AHB. These groups of signals are in compliance with AHB specification.

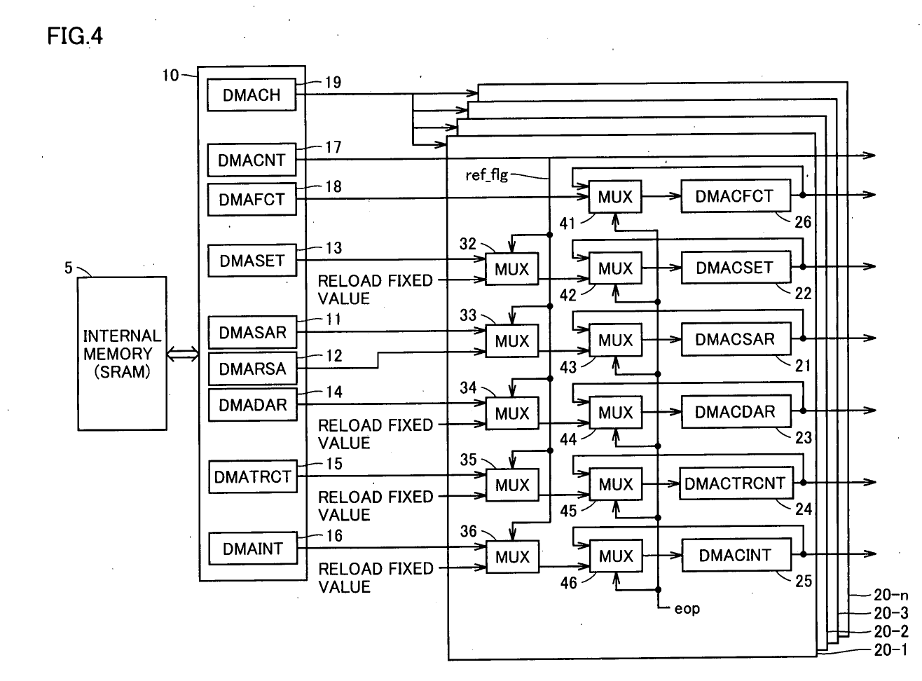

FIG. 4 is a block diagram representing a double-structure of the register groups in the DMAC in accordance with the embodiment of the present invention. Control information of DMAC stored in the SRAM is transferred successively to the register group 10 for next transfer, and written to respective registers 11 to 18. This transfer of control information may be performed after the information of register group 10 for next transfer is transferred to the group of registers 21 to 26 for current transfer, before switching of bus ownership among DMAC channels. Though it takes time to read data from SRAM 5, use of such a protocol enables high speed DMA transfer.

Each of DMA transfer portions 20-1 to 20-n includes multiplexers (MUX) 32 to 36 and 41 to 46. When reloading is to be performed (ref_flg=“0”), multiplexer 33 selects a reload source address set in reload source address register 12 for next transfer, and multiplexers 32, 34, 35 and 36 select a reload fixed value. When reloading is not performed (ref_flg=“1”), multiplexers 32 to 36 select and output values of DMA setting register 13 for next transfer, transfer source address register 11 for next transfer, transfer destination address register 14 for next transfer, DMA transfer register 15 for next transfer and DMA complete register 16.

When current DMA transfer is continuing (eop=“0”), multiplexers 41 to 46 select values of DMA factor register 26 for current transfer, DMA setting register 22 for current transfer, transfer source address register 21 for current transfer, transfer destination address register 23 for current transfer, DMA transfer register 24 for current transfer and DMA complete register 25 for current transfer. Specifically, the group of registers 21 to 26 for current transfer hold the values as they are. Further, multiplexers 42 to 46 select values output from multiplexers 32 to 36 when the current DMA transfer is complete (eop=“1”). At this time, multiplexer 41 selects a value output from DMA factor register 18 for next transfer.

Here, the eop signal is generated by corresponding DMA transfer control portion 28 and indicates that DMA transfer by the corresponding channel has been complete.

For setting values in registers 11 to 19, CPU 2 accesses to internal memory 5, whereby data are transferred from internal memory 5 and the values are set through the 0.9-AHB slave IF. When there is generated a boot request, predetermined fixed values are set in registers 11 to 19.

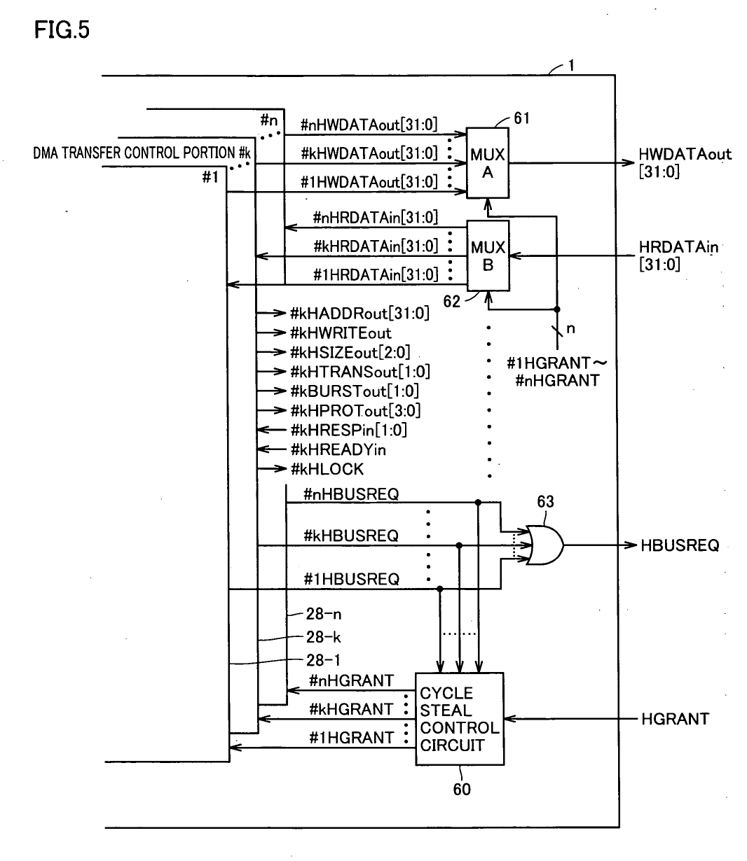

FIG. 5 represents a circuit configuration for controlling a cycle steal of each DMA channel. In the following, DMA transfer control portion 28 in DMA transfer portions 20-1 to 20-n will be referred to as DMA transfer control portions #1 to #n.

Here, a cycle steal refers to the following operation. When there are DMA transfer requests from at least two of the plurality of DMA channels, each of the at least two DMA channels surrenders, after performing transactions of every particular number of transfers set for each channel, its bus ownership to other DMA channel, without intervention of any other bus master such as the CPU. This is a cycle steal.

The particular number of transfers is not limited to one, and the bus ownership may be changed at every prescribed number of transactions. Further, it is unnecessary that the channels have the same particular number of transactions, and different number of transfers may be set for different channels. By way of example, DMAC 1 may surrender the bus ownership to another DMAC after two transactions, and DMAC 2 may surrender the bus ownership to another DMCA after one transaction.

Each of the DMA transfer control portions #1 to #n (hereinafter generally referred to as #k) outputs #kHWDATAout signal, #kHADDRout signal, #kHWRITEout signal, #kHSIZEout signal, #kHTRANSout signal, #kHBURSTout signal, #kHPROTout signal, #kHLOCK signal and #k HBUSREQ signal as output signals, and receives as inputs #kHRDATAin signal, #kHRESPin signal, #kHREADYin signal and #kHGRANT signal.

When the HGRANT signal from arbiter 7 becomes active, a cycle steal control circuit 60 activates any one of #kHGRANT signals of DMA channels of which #kHBUSREQ signal is active, so as to permit DMA transfer. When a DMA transfer is to be performed in the burst mode, bus ownership is controlled such that after a prescribed number of DMA transfers, the bus ownership is granted to a different DMA channel, so that the bus ownership is not occupied by one channel. The order of bus ownership acquisition among channels is determined, for instance, in accordance with round-robin method.

In the round-robin method, a prescribed number of DMA cycles are allotted in a rounding manner to a plurality of DMA channels that are issuing DMA transfer requests. By way of example, a DMA channel that completed a prescribed number of DMA cycles is put on the tail of a queue, and DMA transfer is permitted for the DMA channel that is at the top of the queue. By repeating this operation, DMA cycles can evenly be granted to the plurality of DMA channels issuing DMA transfer requests.

Further, cycle steal control circuit 60 may count the past number of DMA transfer requests of each channel, and may grant the bus ownership with priority to the channel that issued a large number of DMA transfer requests.

An OR circuit 63 operates a logical sum of #LHBUSREQ to #nHBUSREQ signals, and outputs a result as a HBUSREQ signal to arbiter 7. Therefore, when at least one of the channels #1 to #n outputs a DMA request, there will be a DMA transfer request output to arbiter 7.

A multiplexer (MUX-A) 61 selects one of #1HWDATAout to #nHWDATAout signals, and outputs the same as HWDATAout signal. For other output signals of each of the DMA transfer control portions #1 to #n, that is, for #kHADDRout signal, #kHWRITEout signal, #kHSIZE out signal, #kHTRANSout signal, #kHBURSTout signal, #kBPROTout signal and #kHLOCK signal, corresponding multiplexers (MUX-A) are provided, which output HADDRout signal, HWRITEout signal, HSIZEout signal, HTRANSout signal, HBURSTout signal, HPROTout signal and HLOCK signal, respectively.

A multiplexer (MUX-B) 62 selects any one of DMA transfer control portions #1 to #n, and outputs HRDATAin signal as one of #1HRDATAin to #nHRDATAin signals, to the selected DMA transfer control portion. For other input signals of each of the DMA transfer control portions #1 to #n, that is, HRESPin signal and HREADYin signal, corresponding multiplexers (MUX-B) are provided, which outputs these signals as one of #1HRESPin to #nHRESPin signals and one of #1HREADY to #nHREADY signals.

Selection by each of multiplexers 61 and 62 (including those not shown) is controlled by n bits of signals including #1HGRANT to #nHGRANT signals that are outputs of cycle steal control circuit 60. When the signal #kHGRANT as one of these signals is asserted, all multiplexers 61 and 62 select signals corresponding to the DMA transfer control portion #k.

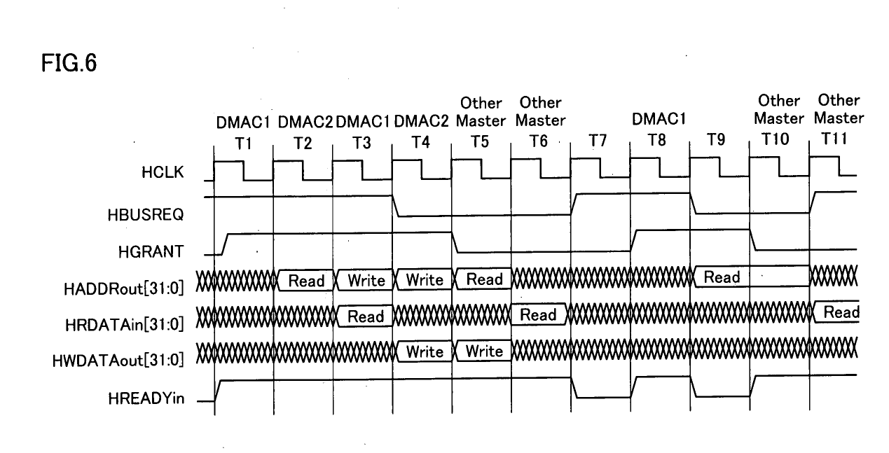

FIG. 6 is a timing chart illustrating acquisition of bus ownership by the DMAC in accordance with an embodiment of the present invention. In FIG. 6, signals represent signals of AHB master I/F. Further, the burst cycle number is set to 1. Bus occupation ratio of DMAC is about 2/3, and it is assumed that when one DMAC transfer corresponding to DMAC 1 and one DMAC transfer corresponding to DMAC 2 end, the bus ownership is once made available to other master. Bus occupation ratio of DMAC changes dependent on the access speed of the memory, that is, whether there is a wait cycle interposed or not.

In cycle T1, HGRANT signal attains active (high level), and the bus ownership is granted to DMAC 1. In cycle T2, a read address corresponding to DMAC 1 is output to HADDRout [31:0], and the bus ownership is granted to DMAC 2.

In cycle T3, the bus ownership is granted to DMAC 1. In this cycle, a write address corresponding to DMAC 2 is output to HADDRout [31:0]. Further, through HRDATAin [31:0], data corresponding to DMAC 1 is read. Here, in the data writing of DMAC2 in this cycle, data that has been read in the last DMAC 2 read cycle (not shown) is written.

In cycle T4, a write address corresponding to DMAC 1 is output to HADDRout [31:0]. In this cycle, data corresponding to DMAC 2 is written through HWDATAout [31:0]. In this cycle, HBUSREQ signal attains inactive (low level), and the bus ownership is once made available to other master. This master corresponds to CPU 2 of FIG. 2.

In cycle T5, a read address corresponding to DMAC 2 is output to HADDRout [31:0]. Further, data corresponding to DMAC 1 is written through HRDATAout [31:0].

In cycle T6, data corresponding to DMAC 2 is read through HWDATAin [31:0]. From cycle 1 to this cycle, HREADYin signal is at the high level. The DMAC recognizes by the HREADYin signal that a wait cycle is not interposed.

In cycle T7, a high level HBUSREQ is output, again requesting bus ownership. In cycle T8, HGRANT signal attains to the high level, that is, the bus ownership is obtained, and DMAC 1 starts DMA transfer. The following cycles are the same as cycles T1 to T6 except that HREADYin signal attains to the low level and a wait cycle is interposed.

In cycle T9, a low level HUBSREQ signal is output and the bus ownership is once abandoned, to maintain a constant bus occupation ratio.

In the DMA controller described above, the particular number of transfers set for respective DMA channels are fixed. The number, however, may be variable. By way of example, a register that can variably set the particular number of transfer may be provided in cycle steal control circuit 60 shown in FIG. 5, and the bus ownership may be surrendered to another DMA channel every time transactions of the number set in the register are completed. CPU 2 shown in FIG. 2 sets a value in the register using AHB slave IF.

Alternatively, in cycle steal control circuit 60, a control circuit may be provided that counts the number of past DMA transfer requests from respective channels, and allows setting of a larger particular number of transfers to the channel that issued large number of requests in the past. By way of example, the number “1” may be set evenly for every DMA channel at first, and thereafter, if a certain DMA channel made N times larger DMA access requests than other DMA channels, the number set for that channel may be changed to “2”, and if the channel made 2N times larger DMA access requests, the number set for that DMA channel may be set to “3”.

When there are three or more DMA channels, the order of bus use may be variable. By way of example, when there are access requests from three DMA channels, the order may be changed from DMA→1→DMA 2→DMA 3→DMA 1→DMA 2→DMA 3→ . . . to DMA 1→DMA 3→DMA 2→DMA 1→DMA 3→DMA 2→ . . . Other than the uniform order of bus use, the order may be changed to DMA 1→DMA 2→DMA 1→DMA 3→DMA 1→DMA 2→DMA 1ΔDMA 3 . . . , when the DMA transfer by DMA 1 should be increased.

As a method of realizing this, a register that sets the order of use is provided in cycle steal control circuit 60 shown in FIG. 5, and the order of bus use by the three or more DMA channels issuing DMA transfer requests is determined in accordance with the order set by the register.

In cycle steal control circuit 60, such a control circuit may be provided that counts past DMA transfer requests by respective DMA channels and determines order of use such that a larger number of use is allotted to a channel that issued a larger number of requests. By way of example, bus ownership may be evenly allotted to respective DMA channels at first, and thereafter, if a certain DMA channel made N times larger DMA access requests than other DMA channels, bus ownership allocation is increased for the DMA channel, and if the channel made 2N times larger DMA access requests, the bus ownership allocation to that DMA channel is further increased.

As described above, by the DMAC in accordance with the present embodiment, when the HGRANT signal from the AHB master becomes active, the bus ownership is granted switched successively to each DMAC, and therefore, not only a cycle steal between the DMAC and other master but also a cycle steal among DMAC channels becomes possible.

Further, cycle steal control circuit 60 determines the order of granting bus ownership to each DMAC channel in accordance with the round robin method, or in accordance with past number of DMA transfers, and therefore, optimal cycle steal becomes possible among DMAC channels.

Further, DMA control information is stored in SRAM 50 and before switching of bus ownership among DMAC channels, successively transferred to the group 10 of registers for next transfer, and therefore, high speed DMA transfer becomes possible.

Although the present invention has been described and illustrated in detail, it is clearly understood that the same is by way of illustration and example only and is not to be taken by way of limitation, the spirit and scope of the present invention being limited only by the terms of the appended claims.

1. A direct memory access controller, comprising:
a plurality of direct memory access transfer portions controlling direct memory access transfer in accordance with values set in a group of registers for current transfer; and
a control portion permitting use of a bus by said plurality of direct memory access transfer portions in a prescribed order such that bus ownership is passed among channels at every prescribed number of transfers, in response to transfer requests from said plurality of direct memory access transfer portions, while the bus ownership is granted from a bus master.

2. The direct memory access controller according to claim 1, further comprising
a group of registers for next transfer;
wherein
said direct memory access transfer portions transfer values set in said group of registers for next transfer to said group of registers for current transfer to control direct memory access transfer.

3. The direct memory access controller according to claim 2, wherein
to said group of registers for next transfer, direct memory access control information stored in an external memory is successively transferred and stored.

4. The direct memory access controller according to claim 3, wherein
transfer of the direct memory access control information from said external memory to said group of registers for next transfer is performed after values stored in said group of registers for next transfer are transferred to any of said plurality of direct memory access transfer portions and before bus ownership is switched among said plurality of direct memory access transfer portions.

5. The direct memory access controller according to claim 1, wherein
said control portion determines order of bus use by said plurality of direct memory access transfer portions in accordance with round robin method.

6. The direct memory access controller according to claim 1, wherein
said control portion determines order of bus use by said plurality of direct memory access transfer portions in accordance with past number of direct memory access transfers by each channel.

7. The direct memory access controller according to claim 1, wherein
in said control portion, number of transfers made by each channel while one continuous bus ownership is being granted is set, and said control portion permits use of the bus among said plurality of direct memory access transfer portions in accordance with said number of transfers.

8. The direct memory access controller according to claim 1, wherein
in said control portion, an order of bus use by channels is set when there are three or more channels, and bus use is permitted among said plurality of direct memory access transfer portions in accordance with the order of bus use.
